(19) United States
(12) Patent Application Publication
(10) Pub. No.: US 2024/0378584 A1
(43) Pub. Date: Nov. 14, 2024

(54) PREDICTIVE SELECTION OF DESIGNATED USERS FOR FULFILLMENT OF SERVICE REQUESTS

(71) Applicant: Wells Fargo Bank, N.A., San Francisco, CA (US)

(72) Inventors: Sirisha AKKALURI, Hyderabad (IN); Biswajit Mishra, Bengaluru (IN); Shiju Thukalankuzhy John, Hyderabad (IN); Shalini Vardhaman Bhandankar, Bangalore (IN)

(21) Appl. No.: 17/655,072

(22) Filed: Mar. 16, 2022

(51) Int. Cl. G06Q 20/32

(52) U.S. Cl. CPC G06Q 20/3223

(57) ABSTRACT

Computer-implemented methods, apparatuses, and computer program products are provided for predictive selection of designated user(s) for the fulfillment of service requests. An example computer-implemented method includes receiving a service request associated with a first user from a first user device. The method further includes determining an unresponsive user event with respect to a first user service response data object provided to the first user device and selecting a designated user from a group of designated users associated with the first user in response to determining the unresponsive user event. The method further includes providing an auxiliary service request data object to a designated user device associated with the selected designated user. The method further includes causing execution of the service defined by the service request for the first user upon receipt of an auxiliary service response data object as provided by the designated user via the designated user device.

### TECHNOLOGICAL FIELD

Example embodiments of the present disclosure relate generally to service requests and, more particularly, to the fulfillment of service requests by designated users.

### BACKGROUND

Users interact with a variety of business, vendors, merchants, and other entities on a daily basis and often receive services that are provided by a particular institution with which they have an associated account. In certain instances, however, users may have difficulty interacting with a particular service or may otherwise be unable to complete the desired service request without assistance.

### BRIEF SUMMARY

As described above, users may desire to receive (e.g., execute) services provided by particular institutions, such as a financial institution, with which the user has an associated account. Certain populations of users (e.g., the elderly, visually impaired, and/or audibly impaired populations), however, may have greater difficulty with completing certain services requests via a user device. Conventionally, these users may be forced to solicit assistance from others to complete these service requests, which may require other individuals to physically located near (e.g., within a proximity of the first user device) in order to properly aid the user. Alternatively, the user may be required to visit a conventional brick-and-mortar location of the institution to complete the service request. These conventional systems and methods not only lead to increased frustration of all parties involved but are also time consuming for the user.

Some traditional systems may attempt to use techniques such as speech-to-text and/or natural language processing (NLP) techniques to infer what the user is requesting. These techniques are often ill-equipped to handle situations where a user is incapable of completing the service request and/or lacks the understanding of what is required to complete the service request. Additionally, such traditional systems are often computationally taxing and require large amounts of computational resources to perform these techniques.

To solve these issues and others, example implementations of embodiments of the present disclosure may allow for the predictive selection of designated users for fulfillment of service requests on behalf of a first user. In operation, embodiments of the present disclosure may receive a service request associated with a first user from a first user device and may determine the occurrence of an unresponsive user event associated with a first user service response data object provided to the first user device. The described systems may further select a designated user from a group of designated users associated with the first user and provide an auxiliary service request data object to a designated user device associated with the designated user. Upon receipt of the auxiliary service response data object from the designated user device, the service defined by a service request from the first user device may be executed such that the service request is fulfilled by the designated user on behalf of the first user. Importantly, embodiments of the present disclosure improve resource-usage efficiency by automatically detecting whether a first user is in need of assistance and automatically selecting a designated user to fulfill the service request on behalf of the user. As such, resources that would otherwise be allotted to the first user device are halted or diverted in instances where the first user is incapable of fulfilling a service request.

In some embodiments, by early detection of a need for a designated user to fulfill a user request on behalf of the first user, various embodiments of the present disclosure enable performing operational load balancing for the service request systems by allocating the appropriate amount of computational resources and deallocating unnecessary computational resources. In this way, various embodiments of the present disclosure enhance operational reliability and resource usage efficiency of service request systems. In this way, the inventors have identified a new system for fulfillment of service requests which were historically unavailable. In doing so, such example implementations confront and solve at least two technical challenges: (1) they provide a new mechanism for fulfillment of service requests, and (2) they minimize storage and computational burdens associated with such service requests.

Systems, apparatuses, methods, and computer program products are disclosed herein for fulfillment of service requests using a designated user. With reference to an example computer-implemented method, a method may include receiving a service request associated with a first user from a first user device. The computer-implemented method may further include determining an unresponsive user event with respect to a first user service response data object provided to the first user device. The computer-implemented method may further include selecting a designated user from a group of designated users associated with the first user in response to determining the unresponsive user event. The computer-implemented method may further include providing an auxiliary service request data object to a designated user device associated with the selected designated user in response to determining the unresponsive user event, wherein the auxiliary service request data object include one or more computer-executable instructions for executing a particular service defined by the service request. The computer-implemented method may further include causing execution of the service defined by the service request for the first user upon receipt of an auxiliary service response data object as provided by the designated user via the designated user device.

In some embodiments, the computer-implemented method may further include providing, in response to receipt of the service request, the first user service response data object to the first user device based at least in part on one or more preferred configuration parameters associated with the first user.

In some embodiments, the computer-implemented method may further include detecting a network connectivity issue event associated with the first user device, wherein the network connectivity issue event is detected in an instance a response to the first user service response data object is not received within a response deadline time window. Additionally, the computer-implemented method may further include determining the unresponsive user event in an instance the network connectivity issue event is detected.

In some embodiments, the computer-implemented method may further include detecting an absence of user interaction event for the first user via the first user device during a user interaction time period, wherein the user interaction time period defined a maximum time period within which the first user may fail to provide user input and is defined by the first user service response data object. Additionally, the computer-implemented method may include determining the unresponsive user event in an instance the absence of user interaction event is detected.

In some embodiments, the computer-implemented method may further include detecting a maximum inaccuracy user interaction event for the first user via the first user device, wherein the maximum inaccuracy user interaction event defines a maximum number of user interactions for a particular instruction associated with the user instruction set and is defined by the first user service response data object. Additionally, the computer-implemented method May include determining the unresponsive user event in an instance the maximum inaccuracy user interaction event is detected.

In some embodiments, the first user service response data object may include (i) one or more computer-executable instructions for executing the particular service defined by the service request and (ii) a user instruction set configured to provide one or more instructions to the first user based at least in part on one or more user configuration preferences associated with the first user.

In some embodiments, the auxiliary service request data object further includes a user instruction set configured to provide one or more instructions to the designated user based at least in part on one or more user configuration preferences associated with the designated user.

In some embodiments, the designated user is selected based at least in part on one or more selection parameters which include a service request type associated with the service request, a location proximity between the first user device and the designated user device, first user preference ranking, or a designated user availability.

In some embodiments, each designated user of the group of designated users is associated with a designated user profile, and each designated user profile includes one or more user configuration preferences and one or more authentication parameters and one or more user permissions associated with the corresponding designated user.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 provides an example predictive data analysis computing entity in accordance with some embodiments discussed herein.

FIG. 3 provides an example computing entity in accordance with some embodiments discussed herein.

FIG. 4 illustrates an example flowchart for causing the execution of a service via a selected designated user, in accordance with some example embodiments described herein.

FIG. 5 illustrates an example flowchart for the determination of unresponsive events, in accordance with some example embodiments described herein.

FIGS. 6-7 illustrate operational examples of first user service response data objects, in accordance with some example embodiments described herein.

FIG. 8 illustrates an operational example of user configuration parameters associated with a user profile, in accordance with some example embodiments described herein.

FIG. 9 illustrates an operational example of a group of designated users associated with a user profile, in accordance with some example embodiments described herein.

### DETAILED DESCRIPTION

Some embodiments of the present disclosure will now be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a predictive data analysis system as an example “apparatus.” However, elements of the apparatus described herein may be equally applicable to the claimed method and computer program product. Thus, use of any such terms should not be taken to limit the spirit and scope of embodiments of the present disclosure.

### Definition of Certain Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as includes, includes, and having should be understood to provide support for narrower terms such as consisting of, consisting essentially of, and included substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used to mean “serving as an example, instance, or illustration.” Any implementation described herein as “example” is not necessarily to be construed as preferred or advantageous over other implementations.

As used herein, the terms “user device,” “mobile device,” “electronic device” and the like refer to computer hardware that is configured (either physically or by the execution of software) to access one or more services made available by a predictive data analysis system (e.g., apparatus or computing device of the present disclosure) and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with a chip or other electronic device that is configured to communicate with the apparatus via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the predictive data analysis system 101 or other computing devices via a network.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Example non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

As used herein, the term “first user device” refers to a user device as defined above that is associated with a first user which may be in network communication with the predictive data analysis system and designated user devices. For example, a first user device may be a computing device of a first user that may request, receive, and/or provide data to or from one of the devices described above. By way of a particular example, a first user device may be a mobile device associated with a first user and used to, in whole or in part, complete a service for the first user. Furthermore, a first user device and associated first user may include a first user profile. Such a first user profile may refer to electronically managed data representing the first user within a computing environment and may include data that embodies and/or uniquely identifies a user within the computing environment. In some embodiments, a first user profile may be associated with user authentication credentials that enables the first user to authenticate themselves as associated with or otherwise having access to a service request and/or first user service response data object as defined hereafter.

As used herein, the term “designated user device” refers to a user device as defined above that is associated with a designated user which may be in network communication with the predictive data analysis system and/or the first user device. For example, a designated user device may be a computing device of a designated user (e.g., second user, third user, . . . n^{th} user) that may request, receive, and/or provide data to or from one of the devices described above. By way of a particular example, a designated user device may be a mobile device associated with a designated user (e.g., second user) and used to, in whole or in part, fulfill a service request on behalf of the first user. Furthermore, a designated user device and associated designated user may include a designated user profile. Such a designated user profile may refer to electronically managed data representing the designated user within a computing environment and may include data that embodies and/or uniquely identifies the designated user (e.g., second user) within the computing environment. In some embodiments, a designated user profile may be associated with user authentication credentials that enables the designated user to authenticate themselves as associated with or otherwise having access to an auxiliary service request data object as defined hereafter.

As used herein, the term “service request” may refer to a data construct configured to describe a requested service by a first user. The service request may be associated with a first user and may be provided via a first user device. The service request may define or otherwise be associated with a particular service requested by the first user. For example, the service request may define a request for a deposit of funds into a first user account or other user account, a transfer of funds to a user account, the withdrawal of funds from a first user account, the checking of an account balance associated with a first user account, the viewing of historical transactions associated with the first user account, the payment of bills using a first user account, and/or the like. Although described herein with reference to a request by the first user, via the first user device, the present disclosure contemplates that the service request may, in some embodiments, be generated and provided to the first user without action on by the first user. By way of a non-limiting example, a financial institution with which the first user maintains an account may request information from the first user in order for the first user to, at the current time or another time, access a service provided by the example financial institution.

As used herein, the term “first user service response data object” may refer to a data construct configured to describe one or more computer-executable instructions for executing the particular service for a first user via the first user device. The first user service response data object may be provided to the first user device in response to a service request by the first user, as part of operation of predictive data analysis system, and/or the like. The one or more computer-executable instructions may define operations for a first user device to perform in order to cause execution of the service as described by the service request. In some embodiments, one or more computer-executable instructions may cause the provision of on-screen instructions and/or audible instructions configured to solicit user input from the first user via the first user device.

As used herein, the term “auxiliary service request data object” may refer to a data construct configured to describe one or more computer-executable instructions for executing the particular service for the first user via a designated user device. The first auxiliary service request data object may be provided to the designated user device, such as in response to the inability of the first user device to complete required operations to receive the service requested by the first user. The one or more computer-executable instructions may define operations for a designated user device to perform in order to cause execution of the service as described by the service request. In some embodiments, one or more computer-executable instructions may cause the provision of on-screen instructions and/or audible instructions configured to solicit user input from the designated user via the designated user device.

As used herein, the term “auxiliary service response data object” may refer to a data construct configured to describe the user input as provided by a designated user in response to the auxiliary service request data object. The auxiliary service response data object may be received from the designated user device.

As used herein, the term “designated user selection machine learning model” may refer to a data construct that describes parameters, hyper-parameters, and/or defined operations of a machine learning model that is configured to process a service request in order to generate an ordered list of designated users. In some embodiments, the designated user selection machine learning model may generate a designated eligibility score for each designated user of a group of designated users. The generated designated eligibility score may be based at least in part on the corresponding one or more designated user parameters associated with the designated user. The generated designated eligibility score may be indicative of the suitability of the designated user to fulfill the particular service request on behalf of the first user. In some embodiments, the designated user selection machine learning model may include a neural network.

The output of the designated user selection machine learning model may include a vector, where each value of the vector describes a designated user and the order of the designated users described by the vector is based at least in part on the associated designated eligibility score. In some embodiments, the designated user selection machine learning model may be trained using historical designated user interaction data as described by historical event request objects. In some embodiments, the designated user selection machine learning model is a rule-based model that is configured to perform one or more operations that are not dependent on any trained parameters, such as one or more mathematical and/or logical operations. In some embodiments, the designated user selection machine learning model may be configured to process designated user parameters associated with a designated user using one or more trained parameters (e.g., one or more trained parameters of a feedforward neural network machine learning model, such as a fully-connected feedforward neural network machine learning model) to generate the designated eligibility score.

Having set forth a series of definitions called-upon throughout this application, an example system architecture and example apparatus is described below for implementing example embodiments and features of the present disclosure.

### Computer Program Products, Methods, and Computing Entities

Embodiments of the present disclosure may be implemented in various ways, including as computer program products that include articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component including higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component including instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that includes combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Example System Framework

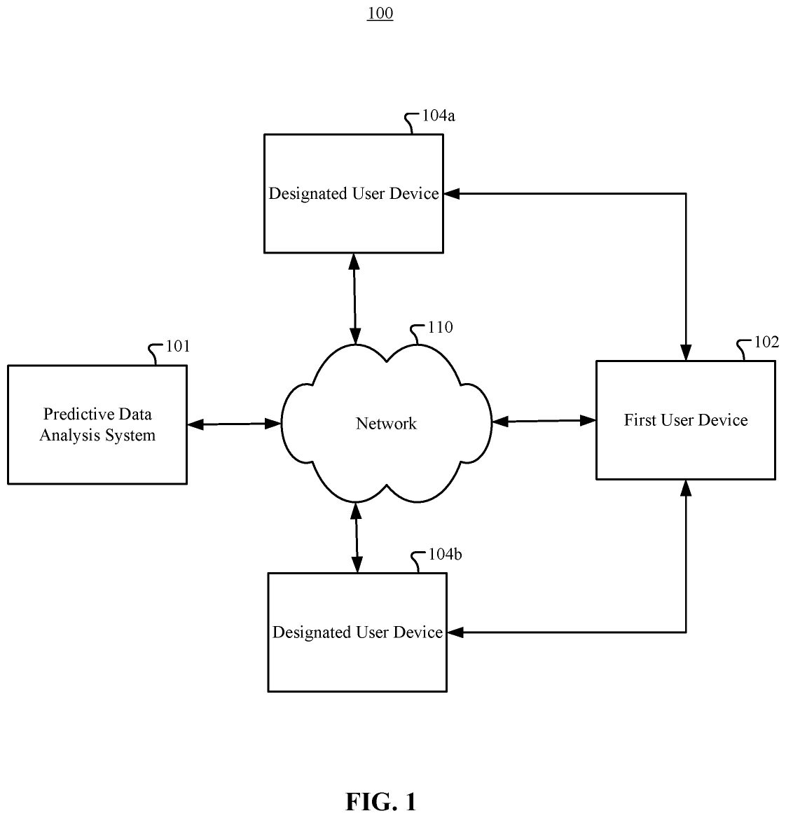

With reference to FIG. 1, an example system 100 is illustrated with an apparatus (e.g., a predictive data analysis system 101) communicably connected via a network 110 to a first user device 102 and one or more designated user devices 104a-104b. As shown, the first user device 102 may be communicably connected with the one or more designated user device 104a-104b.

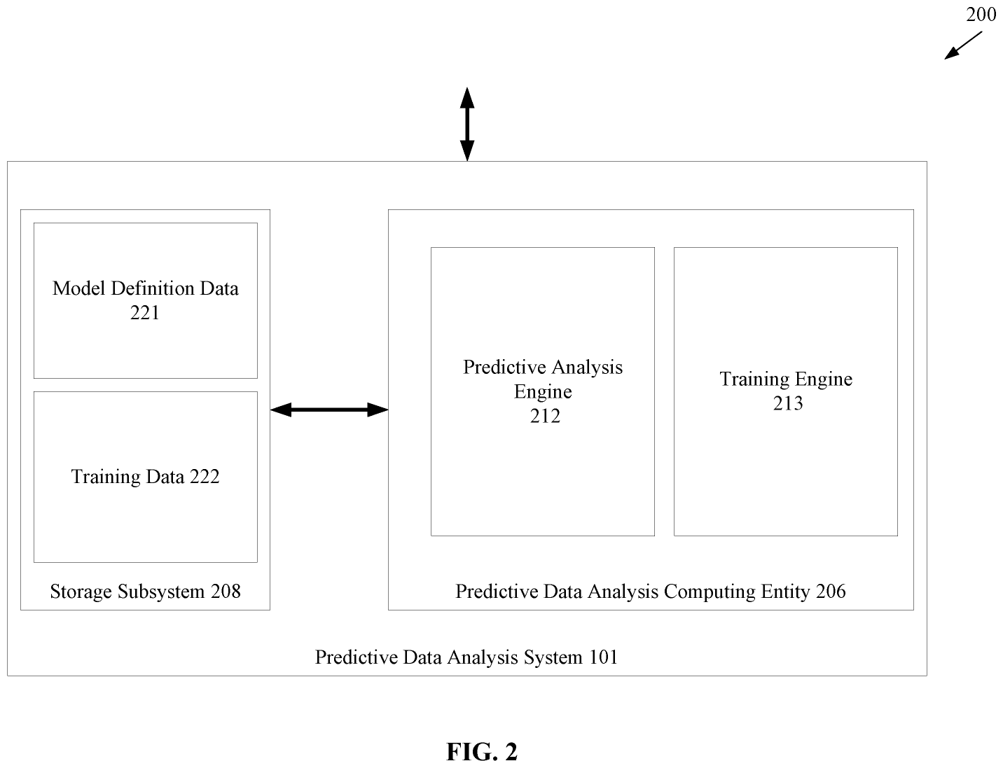

The predictive data analysis system 101 may include circuitry, networked processors, or the like configured to perform some or all of the apparatus-based (e.g., predictive data analysis system-based) processes described herein, and may be any suitable network server and/or other type of processing device. In this regard, predictive data analysis system 101 may be embodied by any of a variety of devices. For example, the predictive data analysis system 101 may be configured to receive/transmit data and may include any of a variety of fixed terminals, such as a server, desktop, or kiosk, or it may include any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the predictive data analysis system 101 may be located remotely from the first user device 102 and/or the designated user device 104a and/or 104b. In other embodiments, the predictive data analysis system 101 may include one or more of first user device 102 and/or the designated user device 104a and/or 104b. Said differently, the present disclosure contemplates that each of the devices illustrated in FIG. 1 may perform operations that occur remotely from or locally to the predictive data analysis system 101. The predictive data analysis system 101 may, in some embodiments, include several servers or computing devices performing interconnected and/or distributed functions. Despite the many arrangements contemplated herein, the predictive data analysis system 101 is shown and described herein as a single computing device to avoid unnecessarily overcomplicating the disclosure.

The first user device 102 may refer to a user device associated with a first user as defined above and may be a cellular telephone (e.g., a smartphone and/or other type of mobile telephone), laptop, tablet, electronic reader, e-book device, media device, wearable, smart glasses, smartwatch, or any combination of the above. The first user device 102 may be configured to, for example, communicate with the predictive data analysis system 101 and provide a service request. Similarly, the designated user devices 104a and/or 104b may each refer to a user device associated with a designated user as defined above and may also be a cellular telephone (e.g., a smartphone and/or other type of mobile telephone), laptop, tablet, electronic reader, e-book device, media device, wearable, smart glasses, smartwatch, or any combination of the above. The second user device 104 may be configured to, for example, communicate with the predictive data analysis system 101 and provide an auxiliary service response data object. Although described hereafter with reference to a first user device 102 and a designated user device 104a and/or 104b, the example system 100 may include any number of user devices associated with the same user or any number of respective other users.

FIG. 2 is a schematic diagram of an example system architecture 100 for performing predictive data analysis operations (e.g., selecting a designated user to fulfill a service request on behalf of the first user). The system architecture 200 includes a predictive data analysis system 101 including a predictive data analysis computing entity 206 configured to generate predictive outputs that can be used to perform one or more prediction-based actions. The predictive data analysis system 101 may communicate with one or more computing entities such as first user device 102 and/or designated user devices 104a and/or 104b using one or more communication networks, such as network 110. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The system architecture 200 includes a storage subsystem 208 configured to store at least a portion of the data utilized by the predictive data analysis system 101. The predictive data analysis computing entity 206 may be in communication with one or more computing entities, such as first user device 102 and/or designated user devices 104a and/or 104b. The predictive data analysis computing entity 206 may be configured to train a prediction model (e.g., designated user selection machine learning model) based at least in part on the training data store 222 stored in the storage subsystem 208, store trained prediction models as part of the model definition data store 221 stored in the storage subsystem 208, utilize trained models to generate an ordered list of designated users based at least in part on event request data and/or designated user parameter data that may be provided by an computing entity. The storage subsystem may be configured to store the model definition data store 221 for one or more predictive analysis models and the training data store 222 uses to train one or more predictive analysis models. The predictive data analysis computing entity 206 may be configured to receive requests and/or data from computing entities (e.g., first user device 102), process the requests and/or data to generate predictive outputs (e.g., a suitable designated user to fulfill a service request for the first user), and take actions based on the predictive outputs (e.g., provide an auxiliary data object to a designated user device 104a or 104b associated with the designated user such that the designated user may perform the service request on behalf of the first user). The computing entity may periodically update/provide raw input data (e.g., service request data) to the predictive data analysis system 101. The computing entities may further generate user interface data (e.g., one or more data objects) corresponding to the received outputs (e.g., a first user service response data object and/or an auxiliary service request data object) and may provide (e.g., transmit, send and/or the like) the user interface data corresponding with the outputs for presentation to user computing entities operated by end-users (e.g., a first user and/or a designated user).

The storage subsystem 208 may be configured to store at least a portion of the data utilized by the predictive data analysis computing entity 206 to perform predictive data analysis steps/operations and tasks. The storage subsystem 208 may be configured to store at least a portion of operational data and/or operational configuration data including operational instructions and parameters utilized by the predictive data analysis computing entity 206 to perform predictive data analysis steps/operations in response to requests. The storage subsystem 208 may include one or more storage units, such as multiple distributed storage units that are connected through a computer network. Each storage unit in the storage subsystem 208 may store at least one of one or more data assets and/or one or more data about the computed properties of one or more data assets. Moreover, each storage unit in the storage subsystem 208 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 206 includes a predictive analysis engine 210 and a training engine 212. The predictive analysis engine 210 may be configured to perform predictive data analysis based at least in part on a received service request. For example, the predictive analysis engine 210 may be configured to select a designated user from a group of designated users and provide an auxiliary request data object to an associated designated user device such that a designated user may fulfill a service request on behalf of the first user. The training engine 212 may be configured to train the predictive analysis engine 210 in accordance with the training data store 222 stored in the storage subsystem 208.

### Example Predictive Data Analysis Computing Entity

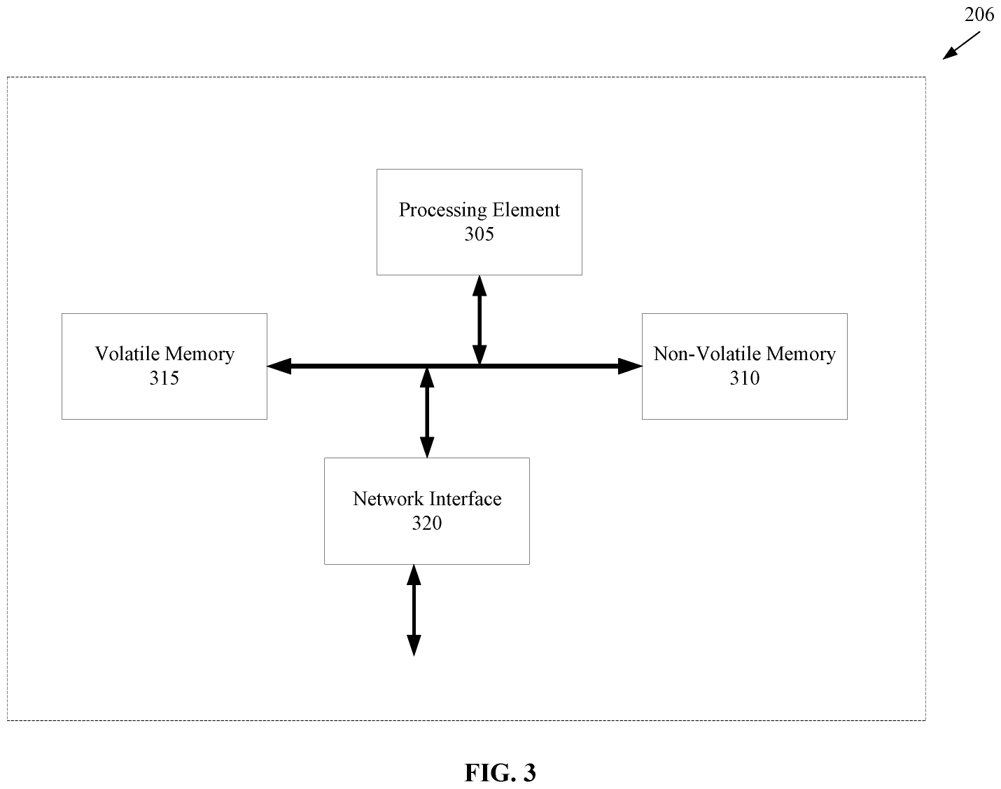

FIG. 3 provides a schematic of a predictive data analysis computing entity 206 according to one embodiment of the present disclosure. Additionally or alternatively, the schematic illustrated in FIG. 3 may also be apply to a first user device 102 and/or designated user device 104a and/or 104b. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably. Although described herein with respect to the predictive data analysis computing entity 206, it should be appreciated that any operations described below may be performed in whole or in part by predictive data analysis computing entity 206 and any other components of the predictive data analysis system 101 may perform the steps, operations, and/or functions.

As indicated, in one embodiment, the predictive data analysis computing entity 206 may also include a network interface 320 for communicating with various computing entities, such as by communicating data, content, information, and/or similar terms used herein interchangeably that can be transmitted, received, operated on, processed, displayed, stored, and/or the like.

As shown in FIG. 3, in one embodiment, the predictive data analysis computing entity 206 may include or be in communication with a processing element 305 (also referred to as processors, processing circuitry, and/or similar terms used herein interchangeably) that communicate with other elements within the predictive data analysis computing entity 206 via a bus, for example. As will be understood, the processing element 305 may be embodied in a number of different ways.

For example, the processing element 305 may be embodied as one or more complex programmable logic devices (CPLDs), microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present disclosure when configured accordingly.

In one embodiment, the predictive data analysis computing entity 206 may further include or be in communication with non-volatile media (also referred to as non-volatile storage, memory, memory storage, memory circuitry and/or similar terms used herein interchangeably). In one embodiment, the non-volatile storage or memory may include at least one non-volatile memory 310, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 206 may further include or be in communication with volatile media (also referred to as volatile storage, memory, memory storage, memory circuitry and/or similar terms used herein interchangeably). In one embodiment, the volatile storage or memory may also include at least one volatile memory 315, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 206 with the assistance of the processing element 305 and operating system.

As indicated, in one embodiment, the predictive data analysis computing entity 206 may also include a network interface 320 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 206 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 206 may include or be in communication with one or more input elements, such as a keyboard input, a mouse input, a touch screen/display input, motion input, movement input, audio input, pointing device input, joystick input, keypad input, and/or the like. The predictive data analysis computing entity 206 may also include or be in communication with one or more output elements (not shown), such as audio output, video output, screen/display output, motion output, movement output, and/or the like.

### Example System Operations

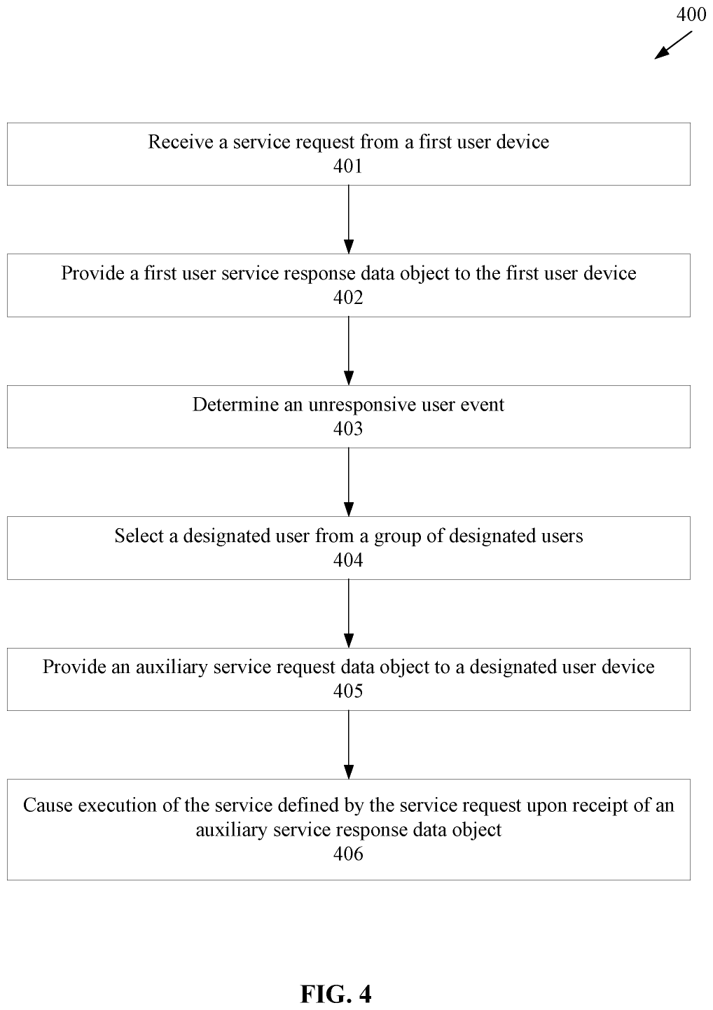

FIG. 4 illustrates a flowchart containing a series of operations for fulfillment of a service request by a designated user associated with the first user. The operations illustrated in FIG. 4 may, for example, be performed by, with the assistance of, and/or under the control of an apparatus (e.g., predictive data analysis system 101), as described above. In this regard, performance of the operations may invoke one or more of the processing element 305, non-volatile memory 310, volatile memory 210, and/or network interface 320. Although described herein with respect to the predictive data analysis computing entity 206, it should be appreciated that any operations described below may be performed in whole or in part by predictive data analysis computing entity 206 and any other components of the predictive data analysis system 101 may perform the below described steps, operations, and/or functions.

As shown in step/operation 401, the apparatus (e.g., predictive data analysis computing entity 206 of predictive data analysis system 101) includes means, such as network interface 320, or the like, for receiving a service request from the first user device 102 associated with the first user. The service request may define a particular service requested by the first user. For example, the service request may define a request for a deposit of funds into a first user account or other user account, a transfer of funds to a user account, a withdrawal of funds from a first user account, a checking of an account balance associated with a first user account, a viewing of historical transactions associated with the first user account, a payment of bills using a first user account, and/or the like. The present disclosure contemplates that the service request received at operation 401 may refer to any service provided by the entity associated with the apparatus without limitation.

The service request may further include first user information and/or first user device information such that the first user may be identified. For example, the service request may include login credentials of the first user such that the first user may be authenticated using the provided login credentials. Login credentials may include any authentication information such as a username, password, biometric data (e.g., fingerprint, retina scans, facial scans, etc.), and/or the like. The predictive data analysis computing entity 206 may then compare the received login credentials to one or more stored login credentials in a user profile associated with the first user and authenticate the first user based at least in part on a comparison between the received login credentials and stored login credentials. If the first user is unable to be authenticated, the predictive data analysis computing entity 206 may request that first user to resend his or her login credentials via the first user device 102 until the first user is successfully authenticated or an unresponsive user event is determined (as described below).

In some embodiments, the first user may provide user identification information in lieu of his or her login credentials. User identification information may include one or more identifying information parameters pertaining to the first user such as his or her first and/or last name, associated phone numbers, associated email, answers to security questions, associated account numbers, and/or the like. The one or more identifying information parameters may be used by the predictive data analysis system 101 to query one or more user databases to identify the first user. If the first user was not authenticated using valid login credentials, the predictive data analysis computing entity 206 may only have limited permissions with respect to accessing the first user account. For example, only a group of designated users associated with the first user may be accessed such that a designated user may be selected in an instance the first user was not authenticated using valid login credentials. As such, if the first user is experiencing difficulty logging into his or her associated account, a designated user may be alerted such that the designated user may be able to assist the first user with completing the service request or may be able to complete the service request on behalf of the first user.

Additionally or alternatively, in some embodiments, first user device parameters may be used to identify the first user. For example, a device identifier (e.g., a phone number, international mobile subscriber identity (IMSI), media access control (MAC) address, and/or the like) may be described or otherwise associated with the service request. The predictive data analysis computing entity 206 may be configured to query one or more databases containing user device information to identify the first user based at least in part on the first user device 102. For example, a first user may be identified by matching the first user device parameters provided in the service request to device parameters stored within an associated first user account. As such, if the first user is unable to provide their login credentials, provides invalid login credentials, and/or fails to provide sufficient identifying information parameters such that the first user may be identified, the predictive data analysis computing entity 206 may still identify the first user using the first user device parameters. However, as described above, the predictive data analysis computing entity 206 may only have limited permissions if the first user is identified without the use of valid login credentials.

As shown in step/operation 402, the apparatus (e.g., predictive data analysis computing entity 206 of predictive data analysis system 101) includes means, such as processing element 305, network interface 320, or the like, for providing a first user service response data object to the first user device 102. In some embodiments, the first user service response data object may be provided to the first user only in instances where the first user was successfully authenticated with his/her login credentials. The first user service response data object may be generated based at least in part on the type of service request defined by the service request received from the first user device 102. In particular, the first user service response data object may include one or more computer-executable instructions for executing the particular service. The one or more computer-executable instructions may define operations for a first user device 102 to perform in order to cause execution of the service. In some embodiments, one or more computer-executable instructions may cause the provision of on-screen instructions and/or audible instructions configured to solicit user input from the first user. User input from the first user may be provided in any suitable form, such as via interaction with the first user device 102 directly or via an accessory (e.g., mouse, keyboard, etc.), through voice commands, and/or the like.

The first user service response data object may be generated based at least in part on one or more preferred configuration parameters associated with the first user. The predictive data analysis computing entity 206 may be configured to query a user profile associated with the first user and determine the one or more preferred configuration parameters prior to generating the first user service response data object. The user profile associated with the first user may be configured with one or more preferred configuration parameters. The one or more preferred configuration parameters may describe user preferences for the first user. For example, the one or more preferred configuration parameters may describe a preferred user display language, audible instruction language, display font size, audible instruction volume, assistance level, instruction preference, notification preference, and/or the like.

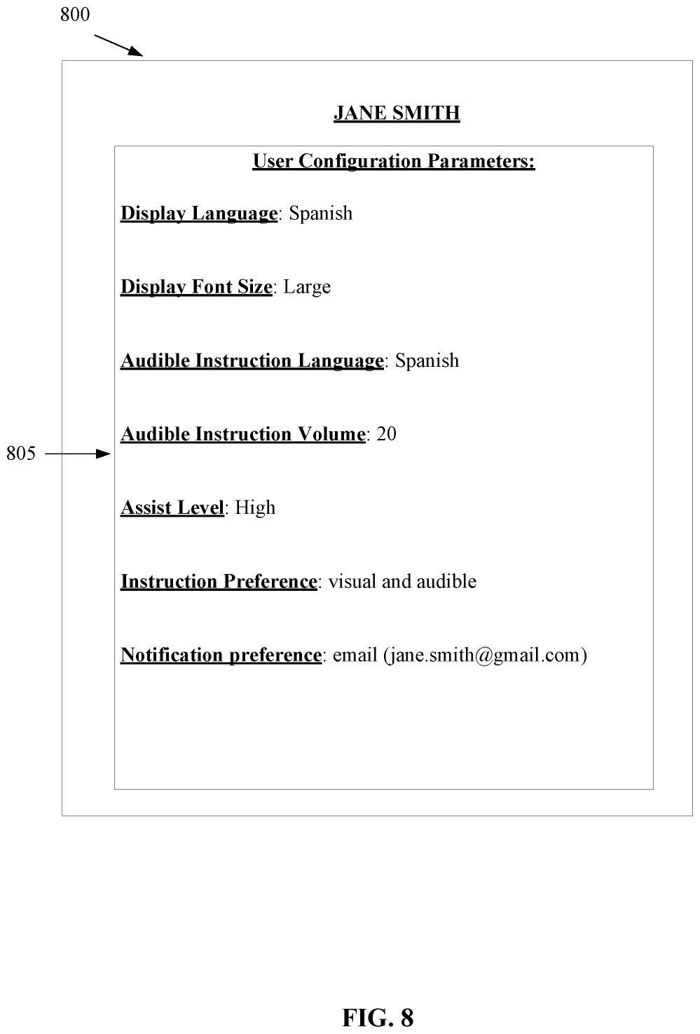

FIG. 8 depicts an operational example of a user profile 800 that is configured with one or more user configuration parameters. The user profile 800 includes one or more user configuration parameters 805 that indicate one or more preferences for a corresponding user (e.g., a first user or designated user). In some embodiments, a user configuration parameter may correspond to a categorical value (e.g., high, medium, low, etc.). Alternatively, a user configuration parameter may correspond to an absolute value (e.g., a numeric value). The predictive data analysis computing entity 206 may be configured to generate the first user service response data object for the first user based at least in part on the one or more configuration parameters 805. For example, if the first user is Jane Smith, a first user service response data object may include a large display font with text displayed in Spanish and audible instructions with a volume of 20 with each instruction provided in Spanish. Furthermore, the first user service response data object may include both visual and audible instructions for each instruction and may provide more detailed instructions due to the high assistance level. Additionally, any correspondence, message, and/or notifications relating to the service request may be provided to the first user via email.

The first user service response data object may further include a user instruction set including one or more instructions that are configured to provide instructions to the first user. The user instruction set may describe instructions required to complete the requested service. For example, if a service request describes a transfer service, the user instruction set may include instructions that direct the first user to the correct input field on the on-screen display to supply a transfer amount, a recipient of the transfer and/or associated account, a date for the transfer to occur, a first user financial account to supply the transfer amount, a memo note, and/or the like. The user instruction set may direct the first user to the correct input field in any suitable manner, such as by highlighting the particular input field of the on-screen display. Additionally or alternatively, the user instruction set may be configured to provide audible instructions to direct the first user to the particular input field on the on-screen display. Once the first user provides user input for a particular input field (via interaction with the first user device 102 directly or via an accessory (e.g., mouse, keyboard, etc.), through voice commands, and/or the like), the user instruction set may be configured to confirm the input field value with the first user before proceeding to the next input field. For example, the user instruction set may solicit user feedback as to whether the input field value is correct, such as by providing a user interface confirmation data field and/or by audibly asking whether the input field value is correct.

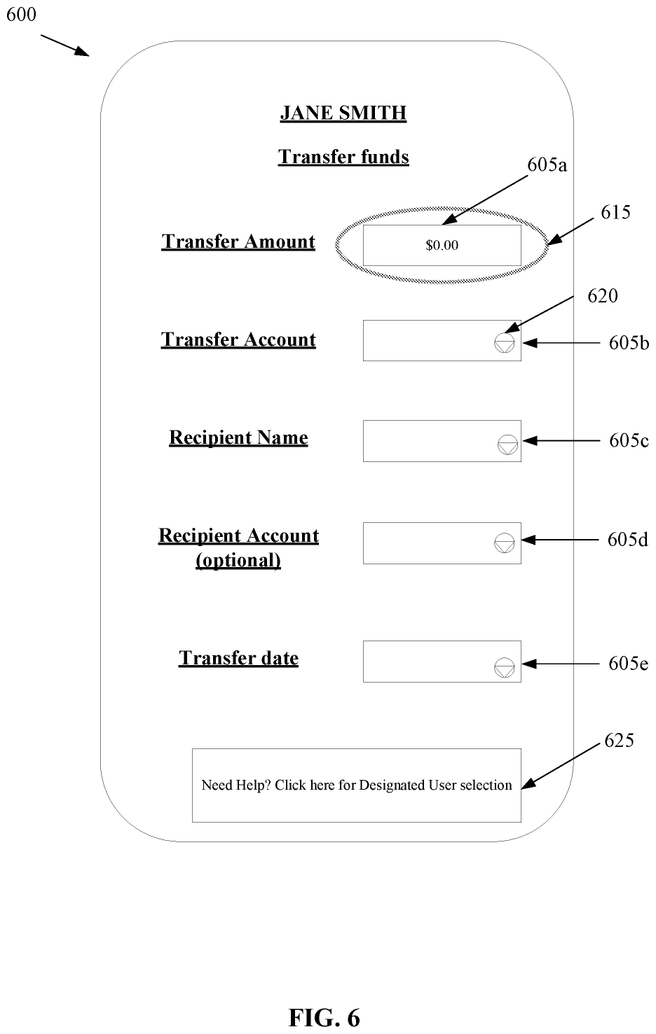

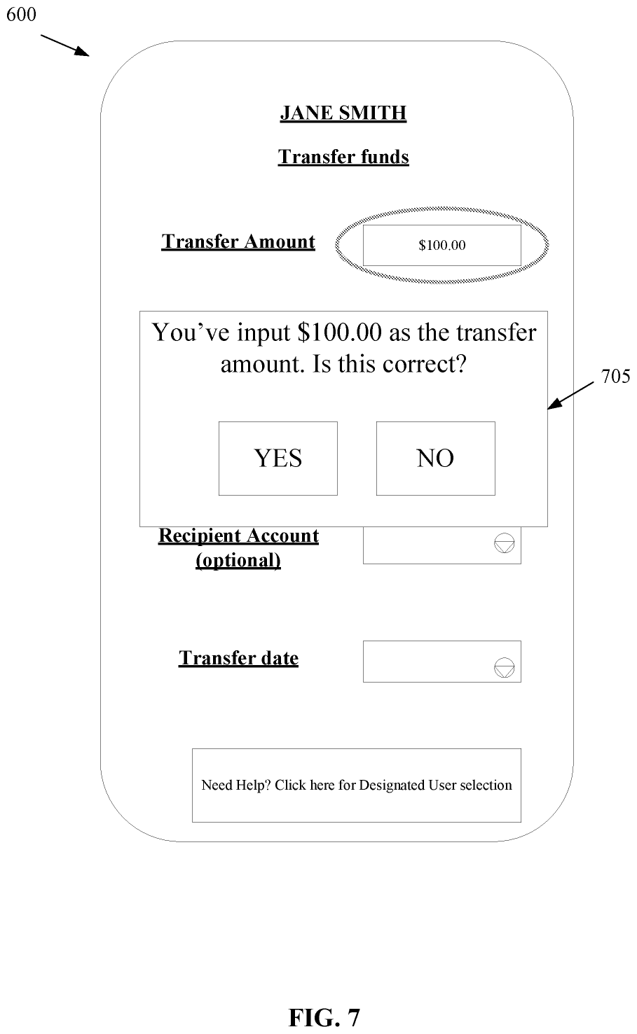

FIGS. 6-7 depict operational examples of a first user service response data object 600. The first user service response data object 600 may include one or more input fields 605a-605e which require user input. The user instruction set may be configured to initially direct the first user to the input field 605a. As shown, the input field 605a is highlighted such that the first user is directed to the user interactable area on the first user device 102, and the first user may provide a user input, such as via interaction with the first user device 102 directly or via an accessory (e.g., mouse, keyboard, etc.). Additionally or alternatively, audible instructions may audibly instruct the user to, “enter the dollar amount you wish to transfer.” The first user may also audibly respond to the instruction, such as by verbalizing “transfer 100 dollars.”

Once the first user provides a user input for input field 605a, the user instruction set may be configured to solicit user confirmation of the input field value. For example, as depicted in FIG. 7, if the first user provides a user input indicative of 100.00, the user instruction set may be configured to generate and display a user confirmation data object 705. The user confirmation data object 705 may be interactable via the first user device 102 and/or may accept voice confirmation from the first user. If the first user does not confirm the input field value, the user instruction set may be configured to clear the value associated with the input field 605a and direct the first user to the input field 605a as described above. Once the first user has confirmed the input field value for input field 605, the user instruction set may be configured to similarly direct the user to the next input field (i.e., input field 605b). The user instruction set may repeat this process until each input field 605a-605e has a confirmed user input.

In some embodiments, each user input field may be associated with one or more recommended input values. The one or more recommended input values may be based at least in part on one or more historical services associated with the first user. For example, if the first user has previously transferred funds from a particular financial account, the first user may be presented with the recommended input value describing that financial account. In some embodiments, the first user may access these recommended input values, such as by selecting a recommended input value interaction element 620, which may display the one or more recommended input values for the particular input field.

In some embodiments, the first user service response data object 600 may include an assistance button 625. The first user may interact with the assistance button 625 (e.g., clicking, touching, audibly requesting the assistance button, or otherwise selecting) to automatically have a designated user selected for the first user. In an instance the first user interacts with the assistance button, an unresponsive user event may be determined (as will be described below) such that a designated user will be selected for the first user and used to fulfill the service request. In an instance the first user successfully completes the first user service response data object, the predictive data analysis computing entity 206 may cause the execution of the service defined by the service request for the first user without a need for the selection of a designated user.

As shown in step/operation 403, the apparatus (e.g., predictive data analysis computing entity 206 of predictive data analysis system 101) includes means, such as processing element 305, network interface 320, or the like, for determining an unresponsive user event. An unresponsive user event may occur with respect to the first user service response data object. Generally, an unresponsive user event may be determined when the predictive data analysis computing entity 206 determines the first user cannot complete the first user service response data object. This determination may be automatically determined by the predictive data analysis computing entity 206 or alternatively, may be determined in response to a request from a first user. For example, if the first user requests assistance (e.g., interacts with the assistance button in the first user service response data object), the predictive data analysis computing entity 206 may determine an unresponsive user event.

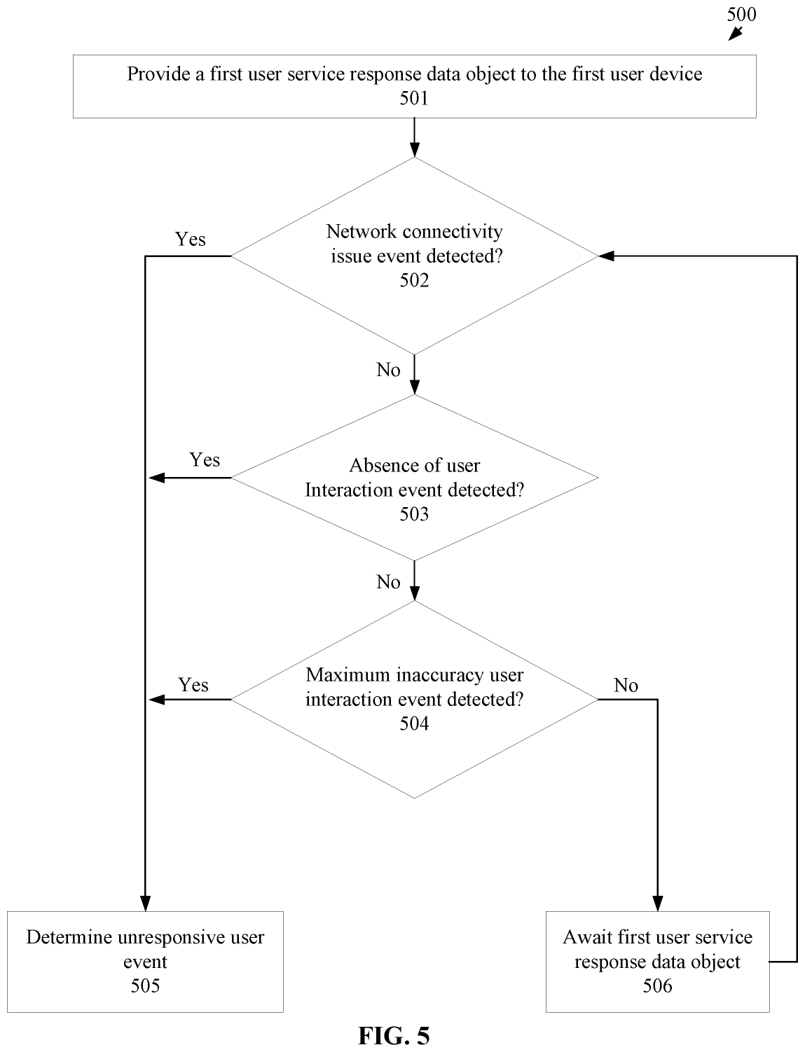

In some embodiments, step/operation 403 may be performed in accordance with the various steps/operations of the process 500 depicted in FIG. 5, which is a flowchart diagram of an example process for determining whether an unresponsive user event has occurred.

As shown in step/operation 501, the apparatus (e.g., predictive data analysis computing entity 206 of predictive data analysis system 101) includes means, such as processing element 305, network interface 320, or the like, for providing the first user response data object to the first user device 102, as described above with respect to step/operation 402 of FIG. 4. Although the step/operations 502-504 are shown in FIG. 5 in a particular order, it will be appreciated that any order of the step/operations 502-504 may be contemplated.

At step/operation 502, the apparatus (e.g., predictive data analysis computing entity 206 of predictive data analysis system 101) includes means, such as processing element 305, network interface 320, or the like, for detecting whether a network connectivity issue has occurred. A network connectivity issue may be detected in any instance the first user device 102 is unreachable. In some embodiments, the network connectivity issue may be detected in an instance a first user service response data object is not received within a response deadline time window. For example, a response deadline time window may have a value of 5 minutes such that if a time greater than 5 minutes has elapsed since the first user service response data object was provided and no first user service response data object is received, a network connectivity issue event is detected.

In some embodiments, the predictive data analysis computing entity 206 may attempt to re-establish connection with the first user device 102. The predictive data analysis computing entity 206 may attempt to re-send the first user service response data object to the first user device 102. Alternatively, the predictive data analysis computing entity 206 may send one or more connection re-establishment messages, such as by using a radio resource connection (RRC) connection re-establishment procedure. If the predictive data analysis computing entity 206 cannot successfully re-establish connection with the first user device 102, the predictive data analysis computing entity 206 may determine a network connectivity issue event is detected.

In an instance a network connectivity issue event is detected, the predictive data analysis computing entity 206 may proceed to step/operation 505, where the predictive data analysis computing entity 206 determines an unresponsive user event has occurred.

In an instance a network connectivity issue event is not detected, the predictive data analysis computing entity 206 may proceed to step/operation 503. At step/operation 503, the apparatus (e.g., predictive data analysis computing entity 206 of predictive data analysis system 101) includes means, such as processing element 305, network interface 320, or the like, for detecting an absence of user interaction event. An absence of user interaction event may be associated with a user interaction time period. The user interaction time period may be defined by the first user service response data object. As such, the first user device 102 is provided the user interaction time period and thus, may be configured to determine whether the first user has failed to provide a user input within the time period defined by the user interaction time period. For example, a user interaction time period may have a value of 1 minute such that if the first user fails to provide a user input after 1 minute, the first user device 102 may notify the predictive data analysis computing entity 206. The predictive data analysis computing entity 206 may then detect an absence of user interaction event has occurred.

In an instance an absence of user interaction event is detected, the predictive data analysis computing entity 206 may proceed to step/operation 505, where the predictive data analysis computing entity 206 determines an unresponsive user event has occurred.

In an instance an absence of user interaction event is not detected, the predictive data analysis computing entity 206 may proceed to step/operation 504. At step/operation 504, the apparatus (e.g., predictive data analysis computing entity 206 of predictive data analysis system 101) includes means, such as processing element 305, network interface 320, or the like, for detecting a maximum inaccuracy user interaction event. A maximum inaccuracy user interaction event may define a maximum number of user interactions for a particular instruction associated with the user instruction set. The maximum number of user interactions may be defined by the first user service response data object. As such, the first user device 102 is provided the maximum number of user interactions and thus, may be configured to determine whether the first user has exceeded a number of user interactions for a particular instruction. For example, a maximum number of user interactions may have a value of 5 such that if the first user provides more than 5 user interactions to the first user device 105 without successfully completing the instruction step, the first user device 102 may notify the predictive data analysis computing entity 206. The predictive data analysis computing entity 206 may then detect a maximum inaccuracy user interaction event has occurred.

In an instance a maximum inaccuracy user interaction event is detected, the predictive data analysis computing entity 206 may proceed to step/operation 505, where the predictive data analysis computing entity 206 determines an unresponsive user event has occurred.

In an instance a maximum inaccuracy user interaction event is not detected, the predictive data analysis computing entity 206 may proceed to step/operation 506, where the predictive data analysis computing entity 206 may await the first user service response data object from the first user device 102. The predictive data analysis computing entity 206 may continuously monitor for network connectivity issue events, the absence of user interaction events, the maximum inaccuracy user interaction events, and/or the like such that the predictive data analysis computing entity 206 may dynamically monitor for the occurrence of unresponsive user events.

Returning now to FIG. 4, as shown in step/operation 404, the apparatus (e.g., predictive data analysis computing entity 206 of predictive data analysis system 101) includes means, such as processing element 305, non-volatile memory 310, volatile memory 315, or the like, for selecting a designated user from a group of designated users. The group of designated users may be associated with the first user. The group of designated users may also be stored in the associated profile of the first user.

In some embodiments, the predictive data analysis computing entity 206 may use a designated user selection machine learning model to select a designated user from a group of designated users. The designated user selection machine learning model may be configured to generate an ordered list of designated users for the first user based at least in part on the group of designated users associated with the user and the service described by the service request. For example, each designated user may be assigned a permissions category by the first user. The permissions category may define one or more rules, permissions, access levels, and/or the like which designated users assigned to the corresponding permissions category may have with respect to the first user. For example, designated users belonging to a high-level permissions category may be allowed to perform any service for the first user and may have access to any financial account associated with the first user. As another example, designated users belonging to a low-level permissions category may be allowed to perform only non-transactional services for the first user and may not have access to any financial account associated with the first user. Any number of permission categories may be defined and/or customized for the first user with respect to the designated users.

The designated user selection machine learning model may evaluate the service request and generate a list of eligible designated users based at least in part on the service described by the service request. That is, designated users which do not belong to a permissions category capable of performing the service are eliminated from consideration while designated users which belong to a permission category capable of performing the service and appended to the list of eligible designated users.

The designated user selection machine learning model may then generate a designated user eligibility score for each designated user of described by the list of eligible designated users. The designated user eligibility score may be generated based at least in part on one or more designated user parameters, such as, an associated designated user availability, a designated user location proximity between the first user device and the designated user device, a first user preference ranking, and/or the like as available. In some embodiments, each designated user of the group of designated users may be associated with a designated user availability describing the dates and/or times the particular designated user is available to complete service requests on behalf of the first user. In some embodiments, the first user may provide a priority ranking indicative of a user preference for the designated users. For example, the first user may assign a priority rank to each designated user such that users associated with the with a higher priority ranking are preferred by the first user over designated users with a lower priority ranking. In some embodiments, the designated user selection machine learning model may be able to determine a location proximity between a first user device and a designated user device for each designated user. For example, the designated user selection machine learning model may determine the location of the first user device based at least in part on the service request, which may identify the location of the first user device. The predictive data analysis computing entity 206 may cause a request for designated user device location for each designated user device location and upon receipt of a response to the request for designated user device location, may determine a designated device location. In some embodiments, if a designated user device is within a relatively close proximity to the first user device 102, the service request may indicate the designated user device. For example, a close proximity for a designated user device may be determined based on a device identifier using the same network connection as the first user device and the service request may include the device identifier within the service request.

The designated user selection machine learning model may be configured to output an ordered list of designated users based at least in part on the associated designated user eligibility score. For example, the ordered list of designated users may list each eligible designated user of the group of designated users in descending order according to the respective designated user eligibility score. The predictive data analysis computing entity 206 may then use the ordered list of designated users to select a designated user for the first user. For example, the predictive data analysis computing entity 206 may be configured to select the designated user in the first position of the ordered list of designated users (i.e., the eligible designated user associated with the highest designated user eligible score).

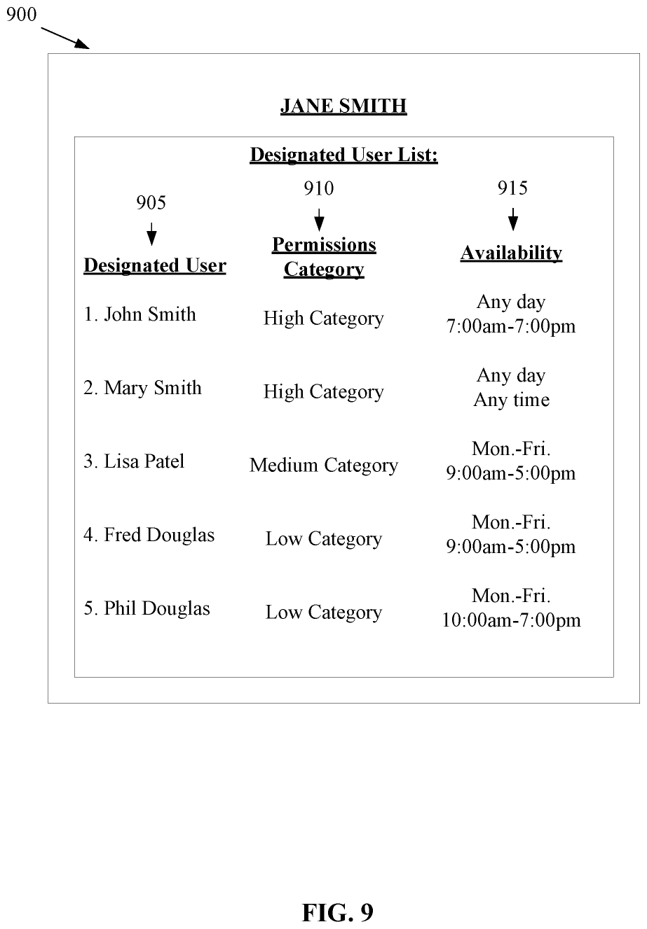

FIG. 9 depicts an operational example of a list of designated users 900 associated with the first user. Each designated user 905 may be associated with a permissions category 910 and an availability 915. Further, each designated user 905 may be associated with a priority ranking as provided by the first user. For example, the designated user ‘John Smith’ may be the first user's first choice for a designated user while the designated user ‘Mary Smith’ may be the first user's second choice. Furthermore, although not shown, each designated user is associated with a designated user profile, which describes at least an associated designated user device.

As shown in step/operation 405, the apparatus (e.g., predictive data analysis computing entity 206 of predictive data analysis system 101) includes means, such as processing element 305, network interface 320, or the like, for providing an auxiliary request data object to a designated user device. Once the designated user is selected by the predictive data analysis computing entity 206, the predictive data analysis computing entity 206 may generate and provide an auxiliary service request data object to the designated user device associated with the designated user. As described above, each designated user associated with the first user may be associated with a designated user profile. The designated user profile may describe at least an associated designated user device for the designated user.

In some embodiments, prior to the provision of the auxiliary request data object, the predictive data analysis computing entity may provide a request for one or more authentication credentials to the designated user device, requesting the designated user to provide such one or more authentication credentials. As such, the designated user may then be authenticated prior to performing actions for the first user. Once the predictive data analysis computing entity 206 receives and authenticates the designated user's authentication credentials, such as by comparing the received authentication credentials to one or more authentication credentials stored in the associated designated user profile, the predictive data analysis computing entity 206 may provide the auxiliary request data object to the designated user device.

The auxiliary request data object may be generated based at least in part on the type of service request defined by the service request received from the first user device 102. In particular, the auxiliary request data object may include one or more computer-executable instructions for executing the particular service. The one or more computer-executable instructions may define operations for a designated user device to perform in order to cause execution of the service. In some embodiments, one or more computer-executable instructions may cause the provision of on-screen instructions and/or audible instructions configured to solicit user input from the designated user. User input may be provided in any suitable form, such as via interaction with the designated user device directly or via an accessory (e.g., mouse, keyboard, etc.), through voice commands, and/or the like.

The auxiliary request data object may be generated based at least in part on one or more preferred configuration parameters associated with the designated user. The predictive data analysis computing entity 206 may be configured to query a designated user profile associated with the designated user and determine the one or more preferred configuration parameters prior to generating the auxiliary request data object. The user profile associated with the designated user may be configured with one or more preferred configuration parameters, similar to that as described above with respect to the first user in step/operation 402. It should be appreciated that in an instance the designated user preferred configuration parameters differ from the first user preferred configuration parameters, the predictive data analysis computing entity 206 may use the preferred configuration parameters associated with the designated user profile rather than the preferred configuration parameters associated with the first user. As such, the predictive data analysis computing entity 206 may allow for the customization of the data object (e.g., first user service response data object or auxiliary service request data object) based on the intended recipient (e.g., first user or designated user, respectively).

The auxiliary request data object may further include a user instruction set including one or more instructions which are configured to provide instructions to the designated user. The user instruction set may describe instructions required to complete the requested service on behalf of the first user 102. For example, if a service request describes a transfer service, the user instruction set may include instructions that direct the designated user to the correct input field on the on-screen display to supply a transfer amount, a recipient of the transfer and/or associated account, a date for the transfer to occur, a first user financial account to supply the transfer amount, a memo note, and/or the like. The user instruction set may direct the user to the correct input field in any suitable manner, such as by highlighting the particular input field of the on-screen display. Additionally or alternatively, the user instruction set may be configured to provide audible instructions to direct the user to the particular input field on the on-screen display. Once the user provides user input for a particular input field (via interaction with the designated user device directly or via an accessory (e.g., mouse, keyboard, etc.), through voice commands, and/or the like), the user instruction set may be configured to confirm the input field value with the designated user before proceeding to the next input field. For example, the user instruction set may solicit designated user feedback as to whether the input field value is correct such as by providing a user interface confirmation data field or by audibly asking whether the input field value is correct.

In some embodiments, the auxiliary request data object may indicate that the first user is having difficult with a service they would like to perform and is requesting assistance from the designated user. As such, if the designated user is within close proximity, the designated user may physically go to the first user and aid the first user with completing the first user service response data object via the first user device. In some embodiments, the auxiliary request data object may include one or more messages from the first user to the designated user. The one or more messages may indicate what the first user would like to accomplish. Prior to providing the auxiliary request data object to the designated user device, the predictive data analysis computing entity 206 may provide a request for one or more messages from the first user via the first user device. If the predictive data analysis computing entity 206 receives the one or more messages within a time window (e.g., within 30 seconds), the predictive data analysis computing entity 206 may include the one or more received messages in the auxiliary request data object. The one or more messages may include voice memos, text memos, videos, screen captures, and/or the like from the first user.

As shown in step/operation 406, the apparatus (e.g., predictive data analysis computing entity 206 of predictive data analysis system 101) includes means, such as processing element 305, network interface 320, or the like, for causing execution of the service defined by the service request for the first user upon receipt of an auxiliary service response data object. Once the designated user has provided user input for each input field required by the auxiliary request data object, the predictive data analysis computing entity 206 may receive an auxiliary user response data object which describes each input field as completed by the designated user on behalf of the first user. Upon receipt of the auxiliary user response data object, the predictive data analysis computing entity 206 may cause execution of the service defined by the service request. The predictive data analysis computing entity 206 may also execute the service based at least in part on the user input provided by the auxiliary user response data object. As such, the requested service by the first user via first user device may be performed by a designated user via a designated user device on behalf of the first user.

In some embodiments, prior to the execution of the service, the predictive data analysis computing entity 206 may send a confirmation data object to the first user device. As such, the first user may be able to confirm the service and associated values as provided by the designated user. In an instance the first user provides an affirmatory confirmation response data object confirming the values of the service as provided by the auxiliary service response data object, the predictive data analysis computing entity 206 may execute the service. In an instance, the first user does not provide an affirmatory confirmation response data object, the predictive data analysis computing entity 206 may analyze the confirmation response data object to determine any value discrepancies identified by the first user. In an instance the first user has provided a different value for any input field, the predictive data analysis computing entity 206 may update the input field value to the value as provided by the first user. If the first user does not provide different values for any input fields and does not confirm the accuracy of the input field values, the predictive data analysis computing entity 206 may not proceed with causing execution of the service.

As described above, various technical challenges are surmounted via technical solutions contemplated herein. For instance, example implementations of embodiments of the present disclosure provide early detection of a need for a designated user to fulfill a user request on behalf of the first user. In operation, embodiments of the present disclosure may receive a service request from a first user via a first user device. The described systems may further determine an unresponsive user event with respect to a first user service response data object as provided to a first user device and may select a designated user from a group of designated users. The described systems may further provide an auxiliary service request data object to the selected designated user and cause execution of the service defined by the service request for the first user upon receipt of an auxiliary service response data object as provided by the designated user via the designated user device. Importantly, embodiments of the present disclosure improve resource-usage efficiency by automatically detecting whether a first user is in need of assistance and automatically selecting a designated user to fulfill the service request on behalf of the user. As such, resources are not further allotted to the first user device in instances where the first user is incapable of fulfilling a service request.

In this way, the inventors have identified that a new system for fulfillment of service requests which were historically unavailable. In doing so, such example implementations confront and solve at least two technical challenges: (1) they provide a new mechanism for fulfillment of service requests and (2) they minimize storage and computational burdens associated with such service requests.

FIGS. 4-5 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the predictive data analysis system 101 and executed by a processor 202 of the predictive data analysis system 101. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### Conclusion

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A computer-implemented method comprising:
receiving, by a predictive data analysis computing entity, a service request associated with a first user from a first user device;
determining, by the predictive data analysis computing entity, an unresponsive user event with respect to a first user service response data object provided to the first user device;
in response to determining the unresponsive user event, generating, by the predictive data analysis computing entity and using a trained designated user selection machine learning model, a designated user eligibility score for one or more designated users associated with the first user, wherein the trained designated user selection machine learning model has been trained using historical designated user interaction data;
selecting, by the predictive data analysis computing entity and using the trained designated user selection machine learning model, a designated user from the one or more designated users associated with the first user based on a corresponding designated user eligibility score;
providing, by the predictive data analysis computing entity, an auxiliary service request data object to a designated user device associated with the selected designated user in response to determining the unresponsive user event, wherein the auxiliary service request data object comprises one or more computer-executable instructions for executing a particular service defined by the service request; and
causing, by the predictive data analysis computing entity, execution of the particular service defined by the service request for the first user upon receipt of an auxiliary service response data object as provided by the designated user via the designated user device.

2. The computer-implemented method of claim 1, further comprising:
providing, by the predictive data analysis computing entity, and in response to receipt of the service request, the first user service response data object to the first user device based at least in part on one or more preferred configuration parameters associated with the first user.

3. The computer-implemented method of claim 2, further comprising:
detecting, by the predictive data analysis computing entity, a network connectivity issue event associated with the first user device, wherein the network connectivity issue event is detected in an instance in which a response to the first user service response data object is not received within a response deadline time window; and
determining, by the predictive data analysis computing entity, the unresponsive user event in an instance in which the network connectivity issue event is detected.

4. The computer-implemented method of claim 2, wherein the first user service response data object comprises (i) one or more computer-executable instructions for executing the particular service defined by the service request and (ii) a user instruction set configured to provide one or more instructions to the first user based at least in part on one or more user configuration preferences associated with the first user.

5. The computer-implemented method of claim 1, further comprising:
detecting, by the predictive data analysis computing entity, an absence of user interaction event for the first user via the first user device during a user interaction time period, wherein the user interaction time period defined a maximum time period within which the first user may provide user input and is defined by the first user service response data object; and
determining, by the predictive data analysis computing entity, the unresponsive user event in an instance in which the absence of user interaction event is detected.

6. The computer-implemented method of claim 1, further comprising:
detecting, by the predictive data analysis computing entity, a maximum inaccuracy user interaction event for the first user via the first user device, wherein the maximum inaccuracy user interaction event defines a maximum number of user interactions for a particular instruction associated with a user instruction set and is defined by the first user service response data object; and
determining, by the predictive data analysis computing entity, the unresponsive user event in an instance in which the maximum inaccuracy user interaction event is detected.

7. The computer-implemented method of claim 1, wherein the auxiliary service request data object further comprises a user instruction set configured to provide one or more instructions to the designated user based at least in part on one or more user configuration preferences associated with the designated user.

8. The computer-implemented method of claim 1, wherein the designated user is selected, by the predictive data analysis computing entity and using the trained designated user selection machine learning model, and based at least in part on one or more selection parameters including a service request type associated with the service request, a location proximity between the first user device and the designated user device, a first user preference ranking, or a designated user availability.

9. The computer-implemented method of claim 8, wherein:
each designated user of a group of designated users is associated with a designated user profile; and
each designated user profile comprises one or more user configuration preferences and one or more authentication parameters associated with the corresponding designated user.

10. A predictive data analysis computing entity comprising, at least one processor and at least one memory including computer program code, the at least one memory and the computer program code configured to, with the processor, cause the apparatus to:
receive a service request associated with a first user from a first user device;
determine an unresponsive user event with respect to a first user service response data object provided to the first user device;
in response to determining the unresponsive user event, generate, using a trained designated user selection machine learning model, a designated user eligibility score for one or more designated users associated with the first user, wherein the trained designated user selection machine learning model has been trained using historical designated user interaction data;
select, using the trained designated user selection machine learning model, a designated user from the one or more designated users associated with the first user based on a corresponding designated user eligibility score;
provide an auxiliary service request data object to a designated user device associated with the selected designated user in response to determining the unresponsive user event, wherein the auxiliary service request data object comprises one or more computer-executable instructions for executing a particular service defined by the service request; and
cause execution of the particular service defined by the service request for the first user upon receipt of an auxiliary service response data object as provided by the designated user via the designated user device.

11. The predictive data analysis computing entity of claim 10, wherein the at least one memory and the computer program code are further configured to, with the processor, cause the apparatus to provide, in response to receipt of the service request, the first user service response data object to the first user device based at least in part on one or more preferred configuration parameters associated with the first user.

12. The predictive data analysis computing entity of claim 11, wherein the at least one memory and the computer program code are further configured to, with the processor, cause the apparatus to:
detect a network connectivity issue event associated with the first user device, wherein the network connectivity issue event is detected in an instance in which a response to the first user service response data object is not received within a response deadline time window; and
determine the unresponsive user event in an instance in which the network connectivity issue event is detected.

13. The predictive data analysis computing entity of claim 10, wherein the first user service response data object comprises (i) one or more computer-executable instructions for executing the particular service defined by the service request and (ii) a user instruction set configured to provide one or more instructions to the first user based at least in part on one or more user configuration preferences associated with the first user.

14. The predictive data analysis computing entity of claim 10, wherein the at least one memory and the computer program code are further configured to, with the processor, cause the apparatus to:
detect an absence of user interaction event for the first user via the first user device during a user interaction time period, wherein the user interaction time period defined a maximum time period within which the first user may provide user input and is defined by the first user service response data object; and
determine the unresponsive user event in an instance in which the absence of user interaction event is detected.

15. The predictive data analysis computing entity of claim 10, wherein the at least one memory and the computer program code are further configured to, with the processor, cause the apparatus to:
detect a maximum inaccuracy user interaction event for the first user via the first user device, wherein the maximum inaccuracy user interaction event defines a maximum number of user interactions for a particular instruction associated with the a user instruction set and is defined by the first user service response data object; and
determine the unresponsive user event in an instance in which the maximum inaccuracy user interaction event is detected.

16. The predictive data analysis computing entity of claim 10, wherein the auxiliary service request data object further comprises a user instruction set configured to provide one or more instructions to the designated user based at least in part on one or more user configuration preferences associated with the designated user.

17. The predictive data analysis computing entity of claim 10, wherein the designated user is selected, using the trained designated user selection machine learning model, and based at least in part on one or more selection parameters including a service request type associated with the service request, a location proximity between the first user device and the designated user device, a first user preference ranking, or a designated user availability.

18. The predictive data analysis computing entity of claim 17, wherein:
each designated user of a group of designated users is associated with a designated user profile, and
each designated user profile comprises one or more user configuration preferences and one or more authentication parameters associated with the corresponding designated user.

19. A computer program product comprising at least one non-transitory computer-readable storage medium storing software instructions that, when executed, cause an apparatus to:
receive a service request associated with a first user from a first user device;
determine an unresponsive user event with respect to a first user service response data object provided to the first user device;
in response to determining the unresponsive user event, generate, using a trained designated user selection machine learning model, a designated user eligibility score for one or more designated users associated with the first user, wherein the trained designated user selection machine learning model has been trained using historical designated user interaction data;
select, using the trained designated user selection machine learning model, a designated user from the one or more designated users associated with the first user based on a corresponding designated user eligibility score;
provide an auxiliary service request data object to a designated user device associated with the selected designated user in response to determining the unresponsive user event, wherein the auxiliary service request data object comprises one or more computer-executable instructions for executing a particular service defined by the service request; and
cause execution of the particular service defined by the service request for the first user upon receipt of an auxiliary service response data object as provided by the designated user via the designated user device.

20. The computer program product of claim 19, wherein the software instructions, when executed, further cause the apparatus to:
provide, in response to receipt of the service request, the first user service response data object to the first user device based at least in part on one or more preferred configuration parameters associated with the first user.
